(19) United States
(12) Patent Application Publication
(10) Pub. No.: US 2026/0109061 A1
(43) Pub. Date: Apr. 23, 2026

(54) BLADE RETENTION MECHANISM HAVING A BLADE CLAMP AND UTILITY KNIFE INCLUDING THE SAME

(71) Applicant: Stanley Black & Decker Inc., New Britain, CT (US)

(72) Inventors: Stephen Rowlay, Bolsover, Derbyshire (GB); Ralf Strauss, Stanley, NC (US); Cole Thomas Sanders, Higganum, CT (US); Gregory Tropea, Berlin, CT (US); Sotir Moliko, Avon, CT (US); Jonathan P. Van Dore, Lititz, PA (US); Christopher Allen Volgado Cate, Durham, NC (US)

(21) Appl. No.: 19/148,799

(22) PCT Filed: Jan. 29, 2024
(86) PCT No.: PCT/US24/13376

§ 371 Date: Jul. 17, 2025

Related U.S. Application Data
(60) Provisional application No. 63/482,195, filed on Jan. 30, 2023.

(51) Int. Cl. B26B 5/00; B23D 51/10; B26B 1/04

(52) U.S. Cl. CPC B26B 5/006; B23D 51/10; B26B 1/04

(57) ABSTRACT

A blade retention mechanism is provided including a blade clamp having a lever portion and a protrusion portion coupled to a first end of the lever portion. The lever portion rotates at the first end of the lever portion between a first open position and a second closed position. The protrusion portion of the blade clamp defines an over-center cam that presses a blade into a blade holder of a knife when the lever portion is rotated into the second closed position.

### CROSS-REFERENCE TO RELATED APPLICATION

This application claims the benefit of U.S. Provisional Application No. 63/482,195, filed Jan. 30, 2023, entitled BLADE RETENTION MECHANISM HAVING A BLADE CLAMP AND UTILITY KNIFE INCLUDING THE SAME, the content of which is hereby incorporated herein as if set forth in its entirety.

### FIELD

The present disclosure generally relates to blade clamps and, more particularly, to blade clamps used in combination with utility knives or oscillating multitools.

### BACKGROUND

A utility knife—also called a box cutter—is a common tool used in various trades and crafts for a variety of purposes. Utility knives may use fixed, folding, retractable, or replaceable blades and come in a wide variety of lengths and styles suited to the particular set of tasks they are designed to perform. For those utility knives with replaceable blades, once the blade is positioned in, for example, a blade holder of the utility knife housing, the blade generally needs to be retained securely in the blade holder. It would not be desirable for the blade, once positioned, to wobble or move within the blade holder. This wobble or movement may cause damage to the item being cut by the utility knife or potential injury to the user of the utility knife.

### SUMMARY

The following disclosure describes non-limiting examples of some embodiments. For instance, other embodiments of the disclosed systems may or may not include the features described herein. Moreover, disclosed advantages and benefits can apply only to certain cases of the inventive concept and should not be used to limit the disclosure. The embodiments disclosed herein each have several aspects, not a single one of which is solely responsible for the disclosure's desirable attributes.

Some embodiments of the present inventive concept provide a blade retention mechanism including a blade clamp having a lever portion and a protrusion portion coupled to a first end of the lever portion. The lever portion rotates at the first end of the lever portion between a first open position and a second closed position. The protrusion portion of the blade clamp defines an over-center cam that presses a blade into a blade holder of a knife when the lever portion is rotated into the second closed position.

In further embodiments, a spring member may be provided between the blade and the blade holder, wherein the protrusion portion of the blade clamp in the second closed position applies pressure to the spring member causing the spring member to compress and apply additional force to the blade in the blade holder.

In still further embodiments, at least one end of the protrusion portion of the blade clamp may engage with a notch or detent in a housing of the knife to further secure the blade to the blade holder.

In some embodiments, the blade may include notches or apertures that further secure the blade to the blade holder of the knife.

In further embodiments, the protrusion portion may further include a peg along a length of the protrusion portion, the peg engaging a slot or notch in the blade holder, the blade and/or a housing of the knife to further secure the blade. In certain embodiments, the peg extends substantially perpendicular to the protrusion portion of the blade clamp.

In still further embodiments, a clamping load provided by the blade clamp on the blade may be from about 8.2 kg to about 16.4 kg.

In some embodiments, the blade clamp may be flush with a housing of a knife in which the blade is provided when the lever portion is in the second closed position.

In further embodiments, the blade holder may be a blade holder of a utility knife or a folding utility knife.

In still further embodiments, the blade holder may be coupled to an oscillating multitool adapter that receives a utility blade and the utility blade may be pressed into the oscillating multitool adapter using the blade clamp.

In some embodiments, the blade clamp may rotate across the blade of the knife to engage the protrusion portion against the blade of the knife causing the blade to flex and further secure the blade to the blade holder.

In further embodiments, the lever portion of the blade clamp may be locked in place by a portion of a housing of the knife extending over at least a portion of the lever portion and the lever portion may only be engageable when the housing of the knife is rotated out of a position.

Still further embodiments of the present inventive concept provide a utility knife including a removeable blade; a blade holder that receives the removeable blade; and a blade clamp. The blade clamp includes a lever portion and a protrusion portion coupled to a first end of the lever portion. The lever portion rotates at the first end of the lever portion between a first open position and a second closed position. The protrusion portion of the blade clamp presses the removeable blade into the blade holder of the utility knife when the lever portion is rotated into the second closed position.

Some embodiments of the present inventive concept provide a blade retention mechanism including an actuator that moves between first and second positions. In the first position, the actuator is held in a forward position and a roller is forced down a ramp to secure a blade in the blade retention mechanism. The actuator is moved into the second position to release the blade from the blade retention mechanism.

In further embodiments, the actuator may be held in the first position by a spring that forces the actuator forward to engage the roller.

In still further embodiments, moving the blade forward may increase the clamping pressure on the blade.

Some embodiments of the present inventive concept provide a debris removal assembly for use with an oscillating multitool. The assembly includes a blade holder that receives a removeable blade and an oscillating multitool adapter coupled to the blade holder. The blade holder and the oscillating multitool adapter each include at least one egress channel therein that allows debris to flow out of the oscillating multitool during use.

In further embodiments, the blade holder may include two egress channels therein and the multitool adapter may include a single egress channel for the debris.

In still further embodiments, the assembly may be received by an oscillating multitool adapter for trapezoidal knife blades.

In some embodiments, oscillating multitools including the assembly may perform at least 180 cuts without jamming.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 illustrates an example utility knife including a blade retention mechanism in accordance with some embodiments of the present inventive concept.

FIGS. 2A and 2B are diagrams illustrating folding of the utility knife in accordance with some embodiments of the present inventive concept.

FIG. 3A is a diagram illustrating a first embodiment of a lever portion of a blade clamp in accordance with some embodiments of the present inventive concept.

FIG. 3B is a diagram illustrating the lever portion of the blade clamp in a closed position in accordance with some embodiments of the present inventive concept.

FIGS. 4A and 4B are diagrams illustrating the utility knife in an unfolded orientation having the lever portion in an open (4A) and closed (4B) in accordance with some embodiments of the present inventive concept.

FIG. 5 is a diagram illustrating a side view of the blade retention mechanism in a locked position in accordance with some embodiments of the present inventive concept.

FIG. 6A is a diagram of an alternative embodiments of the lever portion of the blade retention mechanism in accordance with some embodiments of the present inventive concept.

FIG. 6B is a diagram illustrating the lever portion of FIG. 6A in a closed position in accordance with some embodiments of the present inventive concept.

FIGS. 7A and 7B are side views of the utility knife including the lever portion of FIG. 6A in a closed (FIG. 6A) and open position (FIG. 6B) in accordance with some embodiments of the present inventive concept.

FIGS. 8A and 8B are diagrams illustrating a spring member of the blade retention mechanism in accordance with some embodiments of the present inventive concept.

FIG. 9 is a diagram of a blade holder for an oscillating multitool in accordance with some embodiments of the present inventive concept.

FIG. 10 is a diagram illustrating the blade holder of FIG. 9 positioned on an oscillating multitool in accordance with some embodiments of the present inventive concept.

FIGS. 11A through 11E are diagrams illustrating further embodiments blade clamping mechanisms including an actuator in accordance with some embodiments of the present inventive concept.

FIG. 12 is a diagram illustrating a blade clamping mechanism on blade holder in accordance with some embodiments of the present inventive concept.

FIG. 13 is a diagram illustrating an alternative embodiment of a blade clamping mechanism in accordance with some embodiments of the present inventive concept.

FIGS. 14A, 14B and 14C are front, back and exploded views, respectively, of an adapter and blade holder including egress channels to allow release of debris in accordance with some embodiments of the present inventive concept.

FIG. 15 is a diagram further illustrating the egress channels in accordance with some embodiments of the present inventive concept.

### DETAILED DESCRIPTION

As discussed above, in utility knives or oscillating tools with replaceable blades, once the blade is positioned in, for example, a blade holder, the blade generally needs to be retained securely in the blade holder. It would not be desirable for the blade, once positioned, to wobble or move within the blade holder. This wobble or movement may cause damage to the item being cut by the utility knife or potential injury to the user of the utility knife. Accordingly, embodiments of the present inventive concept provide a blade retention mechanism for use with utility knives, oscillating multitools and the like. As will be discussed further herein, the blade retention mechanism secures a removable/replaceable blade to retain the blade in a blade holder of the tool to decrease the likelihood that the blade will wobble or shake loose from the blade holder.

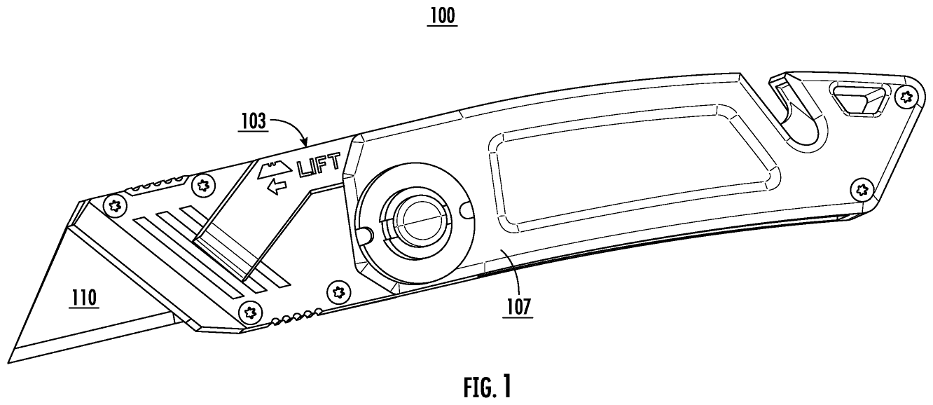

Referring first to FIG. 1, an example utility knife 100 in accordance with the present disclosure will be discussed. In this example, the utility knife 100 is shown in an open, locked orientation, opposed to a folded orientation. The utility knife 100 includes a blade retention mechanism 103 in accordance with the present disclosure. The utility knife 100 includes a housing 107, a blade retention mechanism 103 that secures a replaceable/removable blade 110 to a blade holder (not shown) of the utility knife. It may be understood that such blades 110 conventionally have opposing planar faces separated by one or more edges. At least one edge of the blade 110 is sharpened. In various embodiments, a mounting notch or “mousebite” may be formed in one of the edges, as described in greater detail below. In some embodiments a mounting aperture may extend through the planar faces. It will be understood that the blade 110 may be secured to the utility knife 100 by other means in addition to the blade retention mechanism 103 discussed herein. The blade retention mechanism 103 further secures the blade 110 to reduce wobble and other unwanted movement. Embodiments of the present inventive concept provide a blade and holder connection that results in minimal blade wobble, which as discussed above, provides many advantages. It will be appreciated that the inventive concept discussed herein are compatible with any type of cutting instrument configured to removably receive a blade including, but not limited to, fixed, retractable, or folding knifes as well as oscillating multitools.

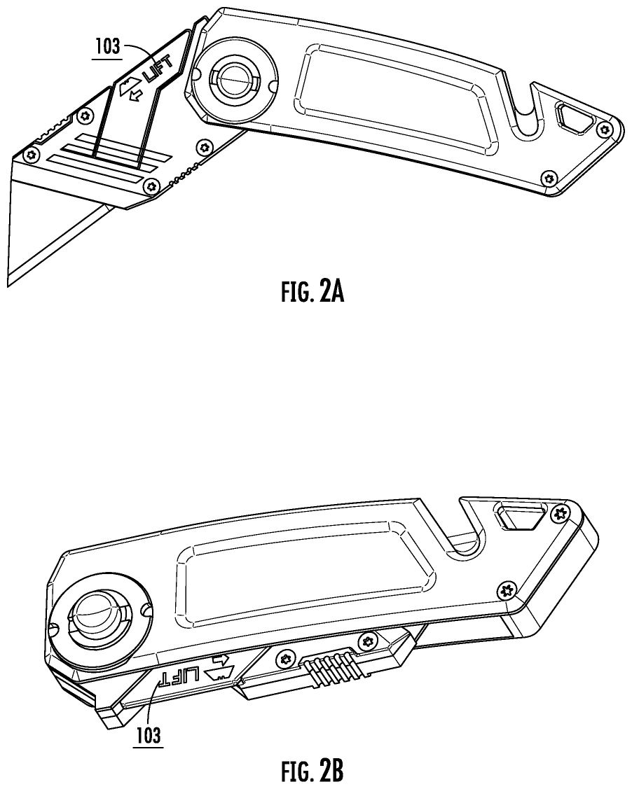

FIGS. 2A and 2B are diagrams illustrating the utility knife 100 including the blade retention mechanism 103 in both partially folded (FIG. 2A) and folded orientations (FIG. 2B). It will be understood that there are many positions in between the orientation illustrated in FIG. 1 and the orientations illustrated in FIGS. 2A and 2B. The figures are provided as examples only. For example, the blade retention mechanism according to embodiments discussed herein may be used on a non-folding knife without departing from the scope of the present inventive concept.

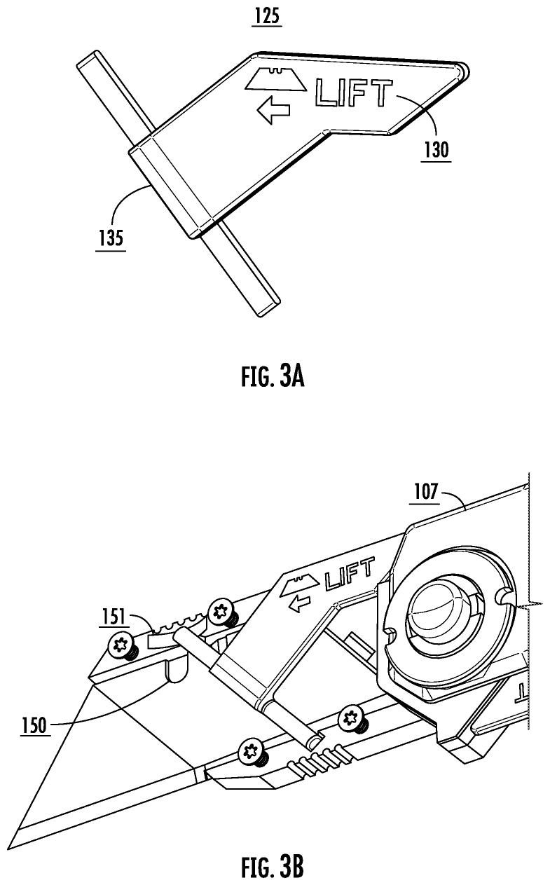

Referring now to FIGS. 3A and 3B, a first embodiment of the blade retention mechanism 103 will be discussed. As illustrated in FIG. 3A, the blade retention mechanism 103 includes a blade clamp 125 that includes a lever portion 130 and a protrusion portion 135. FIG. 3B illustrates the blade clamp 125 positioned in a utility knife 100. A portion of the housing 107 of the utility knife 100 has been removed in FIG. 3B to more clearly illustrate aspects of the present inventive concept. In FIG. 3B, the blade clamp 125 is shown in a closed position.

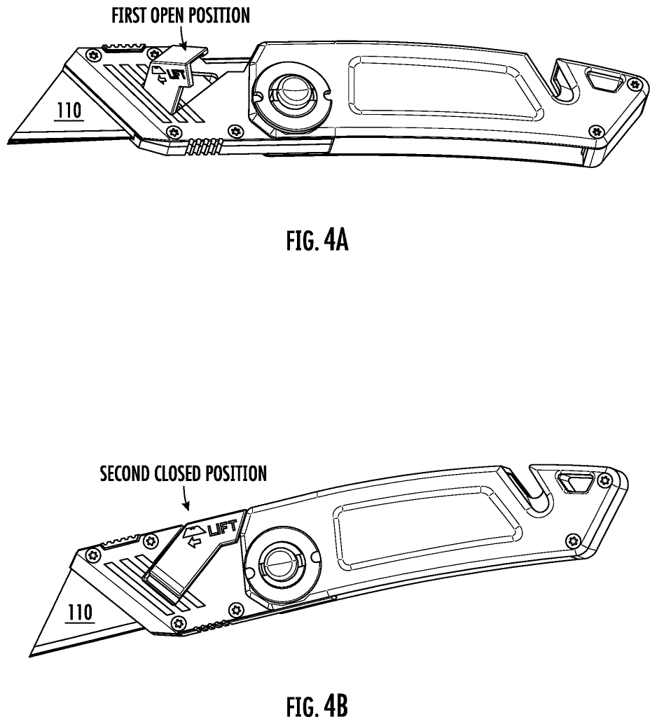

As illustrated in embodiments illustrated in FIGS. 1 through 2B, in some embodiments, the lever portion of the blade clamp 125 is locked in place by a portion of the housing 107 of the utility knife 100 (FIG. 1) and the lever portion 130 is only engageable when the knife is bent into a folding position (FIG. 2A). As illustrated in, for example, FIGS. 4A and 4B, the lever portion 130 can be lifted when the folding knife is locked in the unfolded position. In other words, in embodiments illustrated in FIGS. 4A and 4B, the lever is not obscured by the handle of the knife.

Regardless of whether the lever portion 130 is obscured by the housing or not, in operation, the blade clamp 125/lever portion 130 rotates between a first open position (FIG. 4A) and a second closed position (FIG. 4B). When rotated from the open position (FIG. 4A) to the closed position (FIG. 4B), the protrusion portion 135 of the blade clamp 125 defines an over-center cam that presses a blade 110 into a blade holder of the utility knife 100. Although the protrusion is shown in the figures as having an oblong shape, it will be understood that embodiments of the present inventive concept are not limited to this configuration.

Thus, in the second closed position (FIG. 4A) the blade clamp 125 further secures the blade 110 to reduce the likelihood of wobble or any type of movement during use of the utility knife 100. In other words, the lever arm 130 of the blade clamp 125 rotates across the blade 110 to engage the protrusion 135 against the blade 110 to prevent wobble. The blade clamp may be flush with a housing of a utility knife in which the blade is provided in the closed position.

In some embodiments, the blade clamp of the blade retention mechanism provides a clamping load on the blade is from about 8.2 kg to about 16.4 kg.

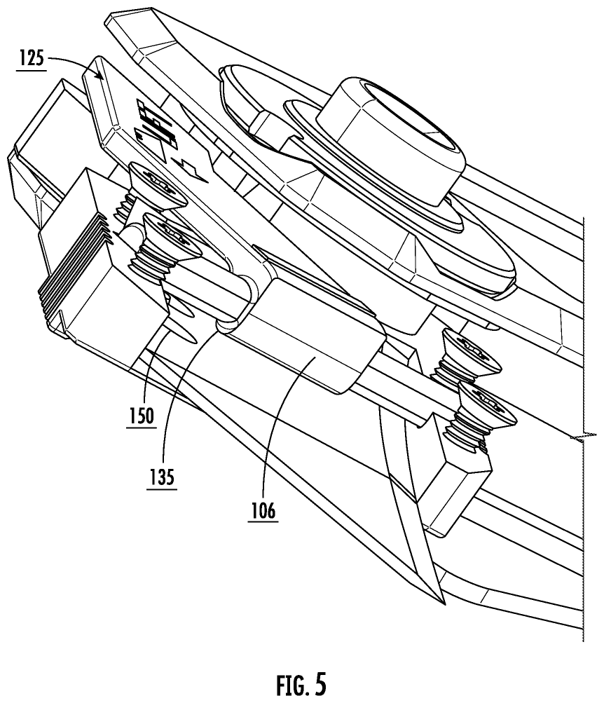

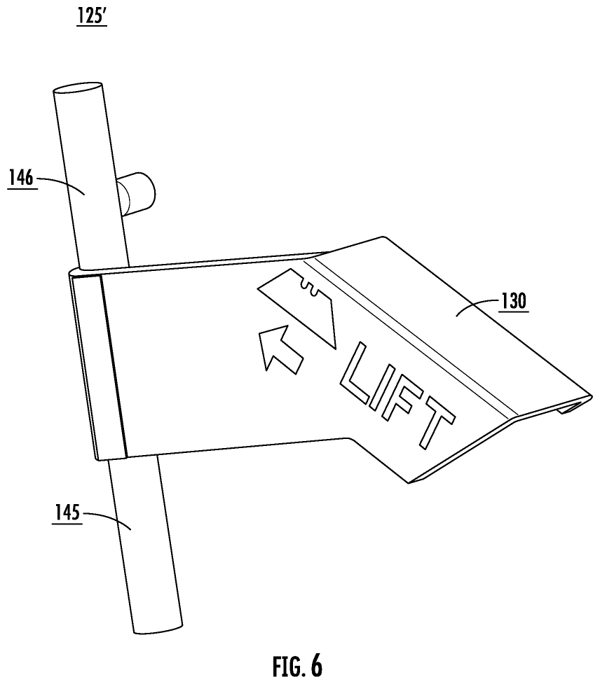

Referring now to FIG. 5, when the blade clamp 125 is in the closed position (FIG. 4B), the protrusion 135 pushes the blade 110 into a back wall of a blade carriage securing the blade 110. When the blade clamp 125 is in an open position (FIG. 4A), a flat region 106 of the blade clamp 125 creates a gap between the blade 110 and the protrusion 135 such that the blade 110 is released and can be removed or replaced.

In embodiments illustrated in FIG. 5, the pushing of protrusion 135 causes the blade 110 to be held against a back wall of a blade carriage received in a notch (e.g., “mousebite”) 150. Thus, the blade 110 is both clamped and the portion of the blade carriage received in the notch 150 reduces the likelihood, or possibly prevents, movement of the blade relative to the blade carriage.

Referring now to FIG. 6, further embodiments of a blade clamp 125′in accordance with some embodiments of the present inventive concept will be discussed. As illustrated in FIG. 6, the blade clamp 125′of FIG. 6 includes a lever portion 130, an oblong portion 145 and a peg 146 on the oblong portion. As will be discussed further below, the peg 146 engages a slot, notch or aperture in the blade holder, the blade and/or a housing of the knife to further secure the blade. In some embodiments, the peg 146 may extend substantially perpendicular to the protrusion of the blade clamp.

It will be understood that although the oblong portion 145 in FIG. 6 only illustrates a single peg 146, embodiments of the present inventive concept may have more than one peg without departing from the scope of the present inventive concept.

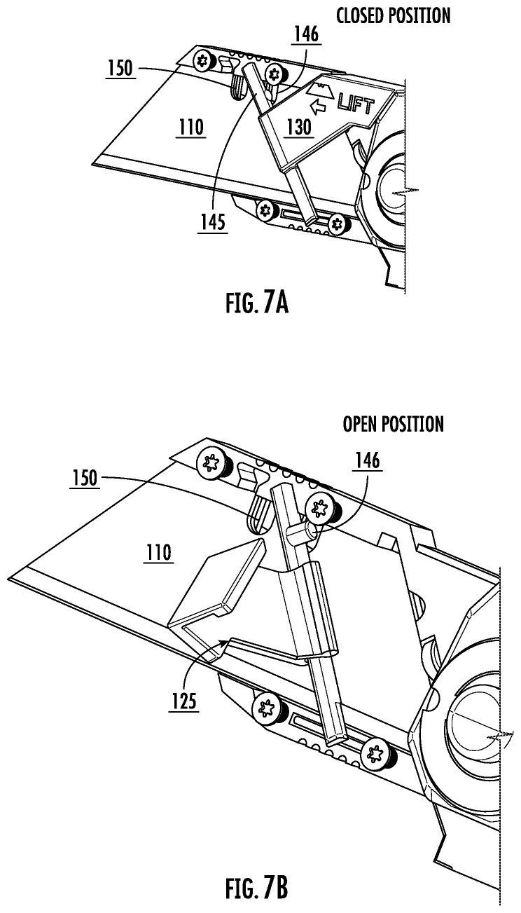

As illustrated in FIG. 7A, in these embodiments, in the closed position the peg 146 of the protrusion portion 145 of the blade clamp 125′engages notch 150 (mousebite) or other apertures in the blade to further secure the blade 110. Thus, in a closed position the clamping force and the engagement into the blade apertures are both from the same direction and, therefore, the blade does not have to be pulled away from the back wall when you want to slide the blade out of the blade carriage when the blade clamp 125′is moved to the open position.

The blade clamp 125′is illustrated in FIG. 7B is an open position. As illustrated, in the open position, the peg 146 of the protrusion 145 is rotated out of the notch 150 and releases the blade 110 so that the blade can be replaced or removed. Although the peg is shown in one position on the protrusion in FIGS. 7A and 7B, it will be understood that the peg 146 may be provided on other portions of the protrusion portion without departing from the scope of the present inventive concept.

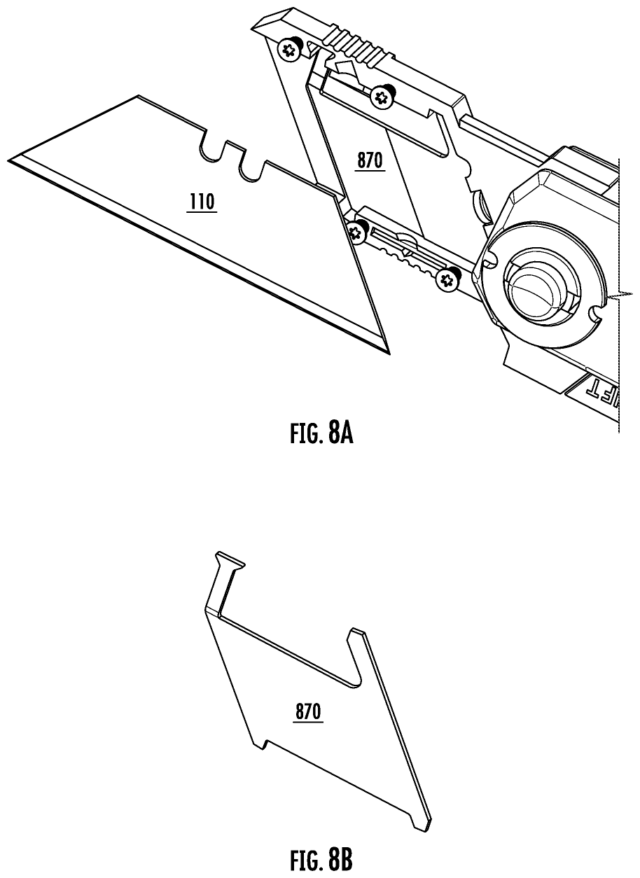

Referring now to FIGS. 8A and 8B, embodiments where the blade retention mechanism 103 further includes a blade spring member 870 will be discussed. As illustrated, the blade spring member 870 is provided between the blade 110 and the blade holder. In operation, when the protrusion of the blade clamp 125 in the second closed position, pressure is applied to the blade spring member causing the spring blade member 870 to compress and apply additional force to the blade 110 in the blade holder.

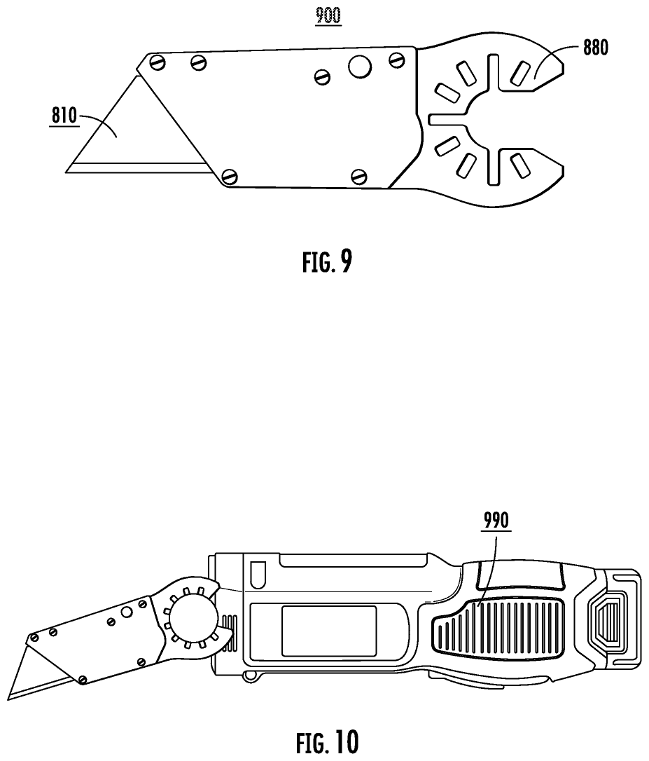

Referring now to FIGS. 9 and 10, in some embodiments of the present inventive concept the blade holder may be coupled to an oscillating multitool adapter that receives a utility blade. Blade clamps in accordance with embodiments discussed herein or other mechanisms, for example, sliders, may be used to secure a blade into an oscillating multitool adapter. As illustrated in FIG. 9, an example adapter 880 is shown having a utility blade 810 positioned therein. In some embodiments, the blade may be pressed into the adapter 880. As illustrated in FIG. 10, the adapter 880 may be received by, for example, an oscillating multitool 990. It will be understood that any tool capable of receiving an adapter 880 may be used without departing from the scope of the present inventive concept.

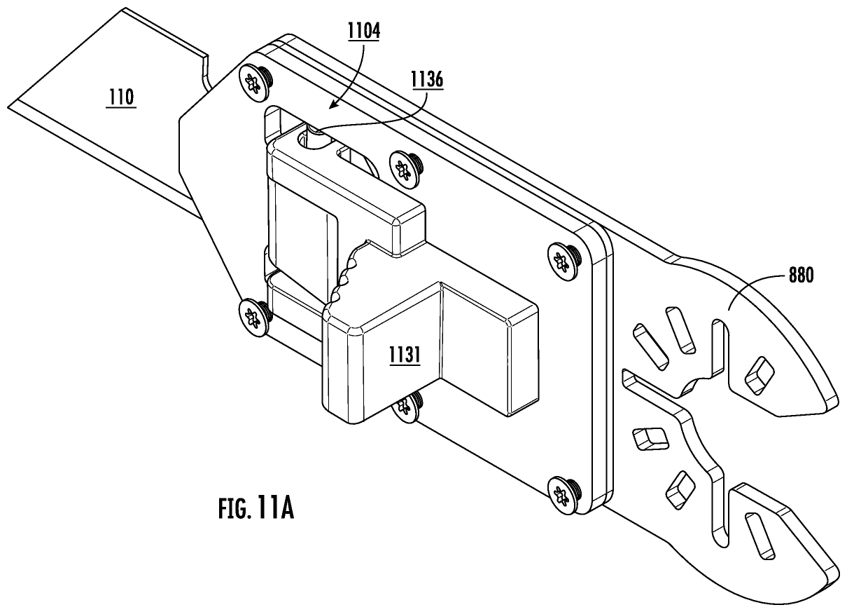

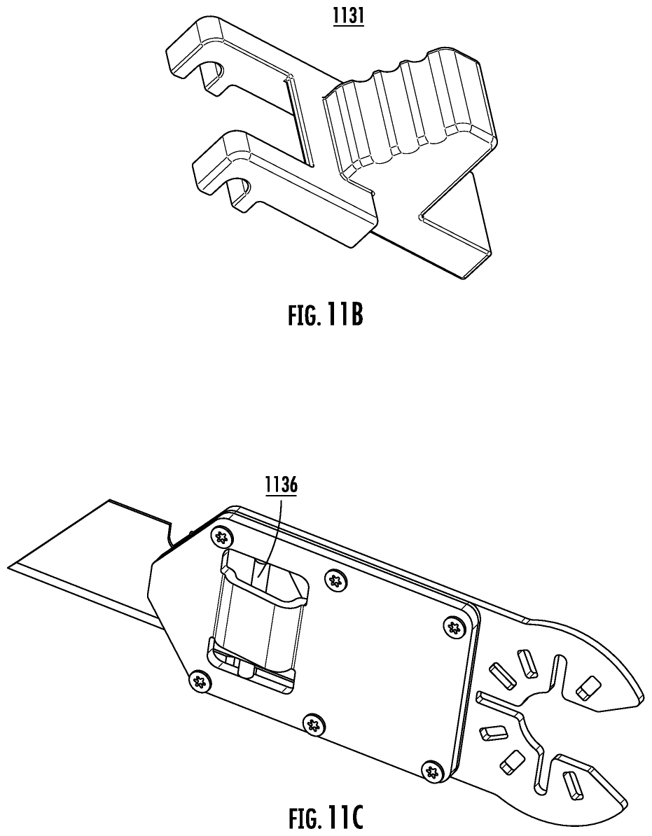

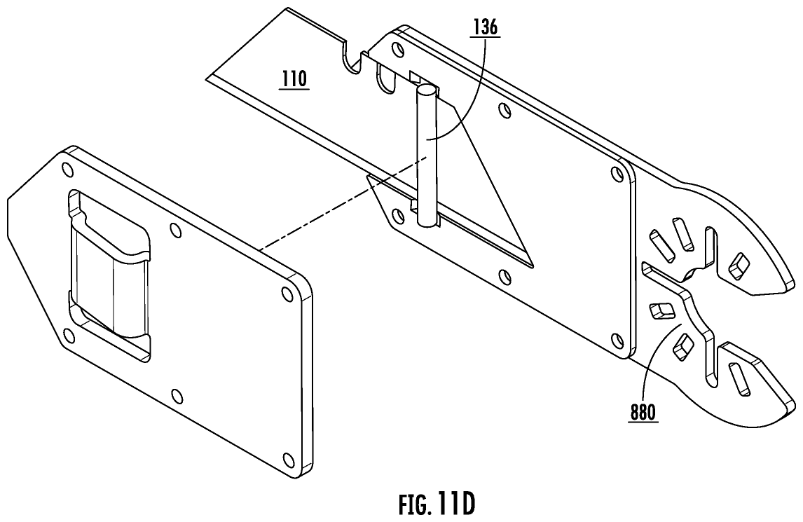

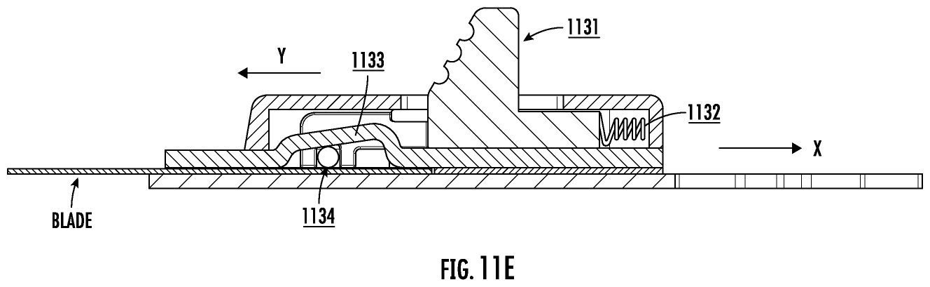

Referring now to FIGS. 11A through 11E, embodiments of a blade retention mechanism 1104 including an actuator 1131 will be discussed. As illustrated in the perspective view of the blade retention mechanism 1104 of FIG. 11A, a blade 110 may be positioned in an adapter 880 and the blade retention mechanism 1104 may be used to secure the blade therein to reduce wobble during use of the tool.

In particular, as illustrated in the centerline cross section of the blade retention mechanism of FIG. 11E, the blade retention mechanism 1104 includes an actuator 1131 (which in the illustrated embodiment comprises a slider), a roller 1136 and a ramp 1133. The actuator 1131 is spring loaded using spring 1132 towards a forward position. Thus, without force, the actuator 1131 stays in the forward position, securing the blade 110. When the actuator 1131 is moved/pulled in the X direction, the blade 110 is released. When the actuator 1131 is in the forward position as illustrated in FIG. 11E, the roller 1136 is forced forward in the Y direction by the actuator 1131 and moves down the ramp 1133 clamping the blade 110. If the blade 110 is pulled forward, the clamping pressure on the blade increases. Although embodiments illustrated in FIG. 11E show a spring holding the actuator 1131 in the forward position, embodiments of the present inventive concept are not limited thereto.

A perspective view of the actuator 1131 is illustrated in FIG. 11B. It will be understood that the actuator 1131 is not limited to the configuration shown in the figures and can be any configuration that allows operations as discussed herein (including, but not limited to a lever configuration). FIGS. 11C and 11D more clearly illustrate the roller 1136, the ramp 1133, and the blade 110 as portions of the mechanism has been removed for clarity purposes.

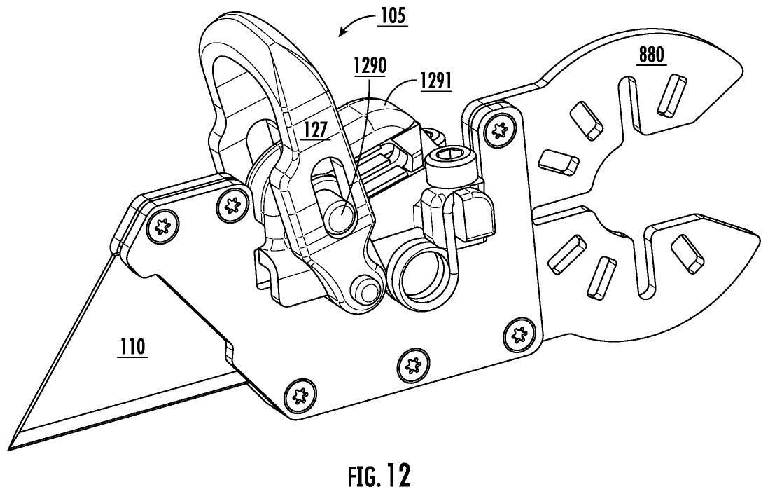

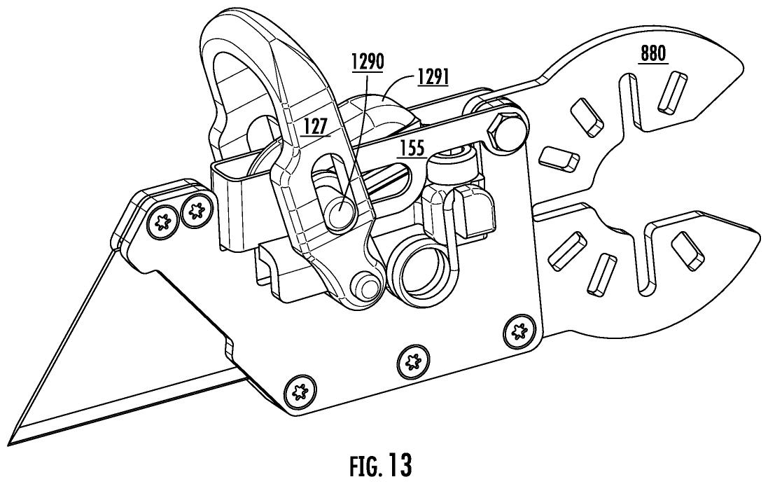

Referring now to FIGS. 12 and 13, alternative embodiments of a blade retention mechanism 105 for use with, for example, a multitool adapter will be discussed. The blade retention mechanism of FIG. 12 illustrates an inline member variant using a clamp mechanism lever. As illustrated the clamp mechanism lever 127 rotates from a first closed position where the blade is secured to the adapter to reduce wobble (shown) to a second open position (not shown) allowing a blade 110 to be inserted or removed. The roller 1290 is spring loaded and acts against a ramp incorporated component 1291 to clamp against a top edge of the blade 110. The lever 127, when rotated to the second open position, operates the roller 1290, moving the roller 1290 up the ramp against the spring pressure and releasing the blade 110. When the blade 110 is pulled forward relative to the blade holder (lever 127 in closed position) the roller 1289 is moved further down the ramp 1291 by the action of the blade 110, which further clamps the blade.

FIG. 13 illustrates a similar clamp mechanism to that illustrated in FIG. 12 with the additional of a catch 155 that holds a mousebite (e.g., one or both of the mousebites on a conventional trapezoidal utility knife blade), as a supplement/failsafe to relying on clamp force alone illustrated in FIG. 12. The catch 155 is operated by the roller 1290 when the lever 127 is rotated to the second open position rotating the catch 155 out of engagement with the blade mousebite allowing the blade to be inserted or removed. It will be understood that embodiments illustrated in FIGS. 12 and 13 are provided for example only and embodiments should not be limited thereto.

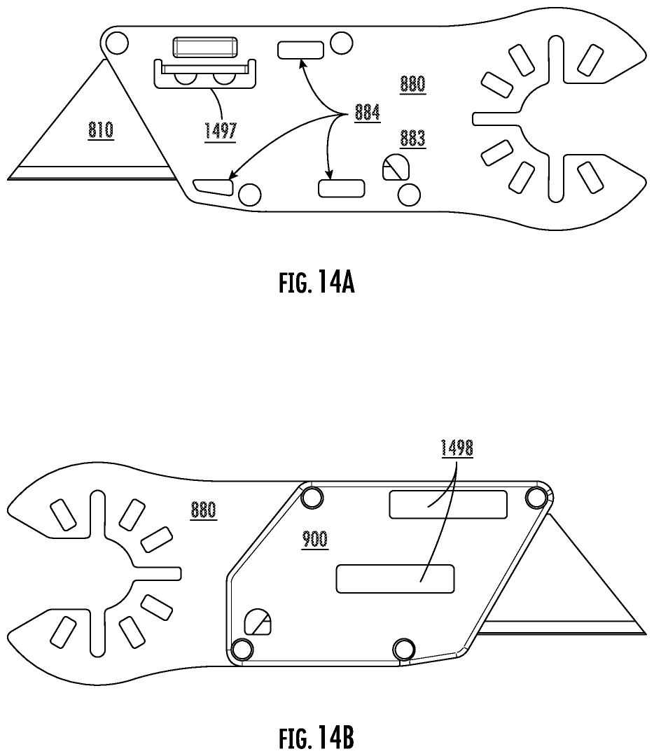

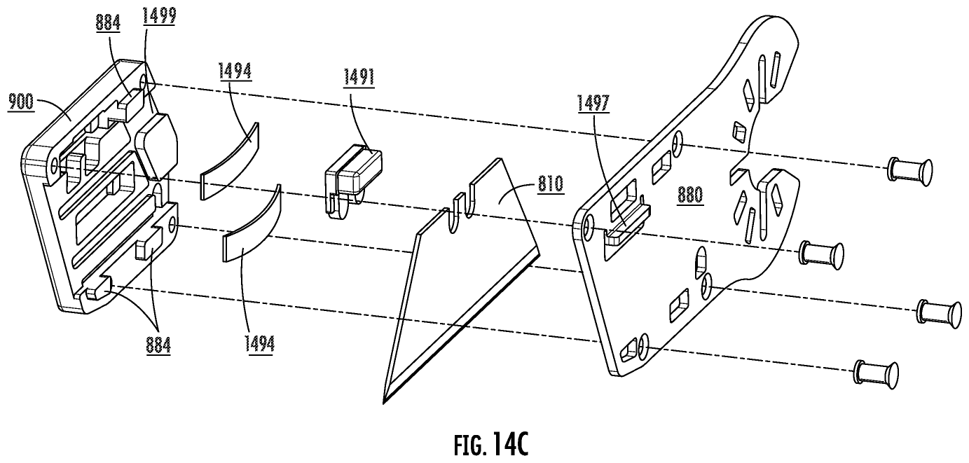

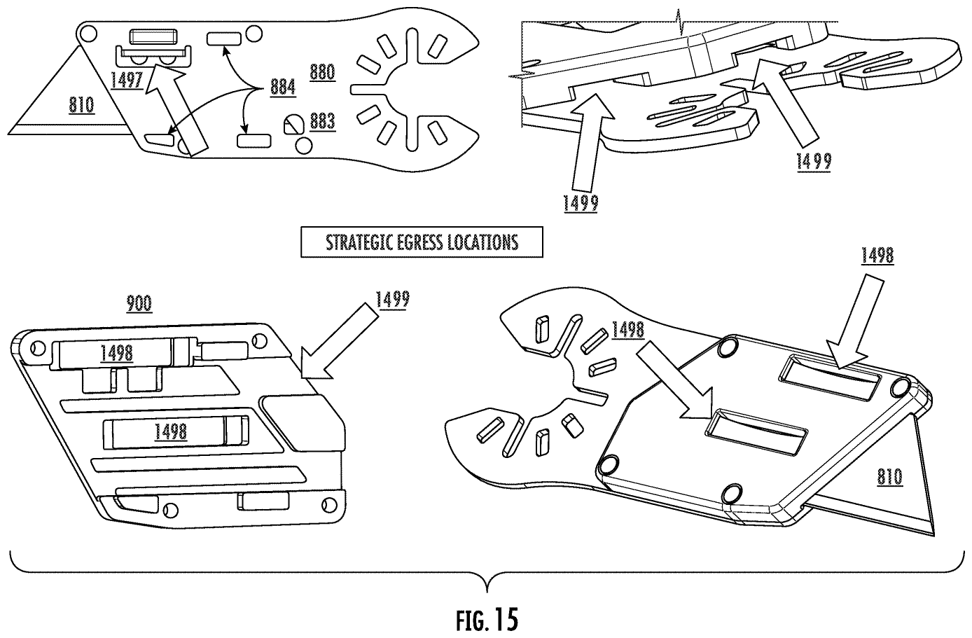

Referring now to FIGS. 14A through 15, embodiments of the present inventive concept including a debris removal assembly including egress points that allow release of debris during use of, for example, the oscillating multi-tool having an adapter positioned therein will be discussed. In particular, in some embodiments, debris builds up in the adapter during use. Certain materials, for example, drywall, may produce a lot of debris that may cause the tool to fail. After significant testing, locations for egress points having a predetermined size have been determined and have been shown to affect the lifespan of the tool between cleanings. It will be understood that the locations and sizes of the egress points discussed herein are provided as example only and other configurations may be contemplated without departing from the scope of the present inventive concept.

Without the egress points discussed with respect to FIGS. 14A through 15 below, the current adapter may fill up and jam after about 15 cuts of 4 ft drywall. For example, the blade may get stuck in the adapter due to the debris behind the button preventing the button from being fully depressed or the blade may not be insertable fully due to the debris behind the blade channel. Including the egress points discussed below, the tool may be used to make appreciably more cuts of 4 ft drywall without any significant jamming. For example, in various embodiments the egress channels may be appropriately sized to dispel debris such that the debris accumulates and the adapter fills after 30 cuts of 4 ft drywall, 60 cuts of 4 ft drywall, 100 cuts of 4 ft drywall, 150 cuts of 4 ft drywall, or so on.

Referring first to FIGS. 14A through 14C, diagrams illustrating a front, back and exploded view, respectively, of an adapter 880 and a blader holder 900. The blade 810 may be held in the blade holder 900 by a blade release button 1491. The blade release button 1491 may be spring biased by a spring 1494 to lock the blade 810 between the blade holder 900 and the adapter 880. The spring 1494 biasing the blade release button 1491 and/or other springs 1494 may also clamp the blade 810 against the adapter 880. It may be appreciated that egress points and channels, in accordance with some embodiments of the present inventive concept, will be discussed. As illustrated in FIGS. 14A and 14B, there may be an egress point 1497 on the front face of the adapter (14A) and there may be additional egress points 1498 in the blade holder 900 (14B). As shown, in an embodiment the blade egress points 1498 may be positioned behind the springs 1494 and the blade release button 1491. FIG. 14C illustrates an exploded view of the adapter 880, the blade 810 and the blade holder 900 and the egress points 1497 and 1498 are clearly visible. Additionally shown in FIG. 14C is a debris egress channel 1499 that may be defined by grooves that extend to openings at the rear of the blade holder 900 (e.g., the debris egress channel 1499 as an opening between the blade 810 and the blade holder 900 such that debris may exit backwards away from the cutting surface of the blade 810.

FIG. 15 further illustrates the various egress locations and the flow of debris therefrom. Without these strategically placed egress channels in the adapter and the blade holder, the buildup of debris may prevent the blade 810 from being inserted or may cause the blade 810 to be ejected or stuck. Accordingly, embodiments of the present inventive concept including the egress channels provide a tool that may be used to make a significant number of cuts without any jamming. In various embodiments, the egress points may be sized and positioned to expel debris in an optimal manner. It may be appreciated that the size of the egress points may be smaller yet positioned in a location that facilitates easier flow of debris, or may be larger yet positioned in a location that is less efficient in flowing debris, but cumulatively achieves a similar effect. In some embodiments the egress points may be utilized together. In various embodiments the egress points maybe approximately 1 mm², approximately 2 mm², approximately 5 mm², approximately 10 mm², approximately 15 mm² or so on.

Additional features of the assembly are also illustrated in FIGS. 14A through 15. For example, a witness hole 883 is shown on the adapter 880 of FIG. 14A. Also shown in FIGS. 14C and 15. The witness hole 883 is provided on the adapter to make sure the blade 810 is fully inserted and to reduce risk of not fully inserting blade and the complications associated therewith. As further illustrated in FIGS. 14A and 14C, a passthrough lug assembly 884 is further included in embodiments. In these embodiments, the passthrough lug assembly comprises features on both the adapter 880 (FIG. 14A) and the blade holder 810 (FIG. 14C). The passthrough lug assembly 884 is provided to remove the shear stress on the fasteners, for example, rivets or screws. Removing this stress provides a more durable tool that withstands use for a longer period of time.

It will be understood that embodiments of the debris removal assembly illustrated in FIGS. 14A through 15 are provided for example only and that embodiments of the present inventive concept are not limited thereto.

As briefly discussed above, embodiments of the present inventive concept provide a blade retention mechanism for use with utility knives, oscillating multitools and the like. The blade retention mechanism secures a removeable/replaceable blade to the knife/tool to reduce the likelihood, or possibly prevent, wobble. As illustrated in the figures and discussed above, the blade retention mechanism may have many different form factors, but each provides further stabilization of blade positioned in the various tools. Furthermore, some embodiments provide additional egress channels to allow release of debris during use to prevent jamming or other failure of the tool.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Depending on the embodiment, certain operations, acts, events, or functions of any of the routines described elsewhere herein can be performed in a different sequence, can be added, merged, or left out altogether (non-limiting example: not all are necessary for the practice of the algorithms). Moreover, in certain embodiments, operations, acts, functions, or events can be performed concurrently, rather than sequentially.

These and other changes can be made to the inventive concept in light of the above Detailed Description. While the above description describes certain examples of the inventive concept, and describes the best mode contemplated, no matter how detailed the above appears in text, the inventive concept can be practiced in many ways. Details of the system may vary considerably in its specific implementation, while still being encompassed by the inventive concept disclosed herein. As noted above, particular terminology used when describing certain features or aspects of the inventive concept should not be taken to imply that the terminology is being redefined herein to be restricted to any specific characteristics, features, or aspects of the inventive concept with which that terminology is associated. In general, the terms used in the following claims should not be construed to limit the inventive concept to the specific examples disclosed in the specification, unless the above Detailed Description section explicitly defines such terms. Accordingly, the actual scope of the inventive concept encompasses not only the disclosed examples, but also all equivalent ways of practicing or implementing the inventive concept under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described elsewhere herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

1. A blade retention mechanism for retaining a blade in a blade holder, the blade retention mechanism comprising a blade clamp including a lever portion and a protrusion portion coupled to a first end of the lever portion, wherein the lever portion is rotatable about the first end of the lever portion between a first open position and a second closed position, and wherein the protrusion portion of the blade clamp defines an over-center cam that presses the blade into the blade holder when the lever portion is rotated into the second closed position.

2. The blade retention mechanism of claim 1, further comprising a spring member between the blade and the blade holder, wherein the protrusion portion of the blade clamp in the second closed position applies pressure to the spring member causing the spring member to compress and apply additional force to the blade in the blade holder.

3. The blade retention mechanism of claim 1, wherein the blade holder comprises a housing having a notch or detent, and wherein at least one end of the protrusion portion of the blade clamp is positioned to engage with the notch or detent in the housing to further secure the blade to the blade holder.

4. The blade retention mechanism of claim 1, wherein the blade holder comprises a slot or notch, and wherein the protrusion portion further comprises a peg along a length of the protrusion portion, the peg positioned to engage the slot or notch in the blade holder or the blade to further secure the blade.

5. The blade retention mechanism of claim 4, wherein the peg extends substantially perpendicular to the protrusion portion of the blade clamp.

6. The blade retention mechanism of claim 1, wherein a clamping load provided by the blade clamp on the blade is from about 8.2 kg to about 16.4 kg.

7. The blade retention mechanism of claim 1, wherein the blade holder comprises a housing, and when a blade is being installed in the blade holder, the blade clamp is flush with the housing when the lever portion is in the second closed position.

8. The blade retention mechanism of claim 1, wherein the blade holder is a utility knife or a folding utility knife.

9. The blade retention mechanism of claim 1, wherein the blade holder is an oscillating multitool adapter that receives a utility blade, and wherein the utility blade is pressed into the oscillating multitool adapter using the blade clamp.

10. The blade retention mechanism of claim 1, wherein the blade clamp is configured to rotate across the blade to engage the protrusion portion against the blade causing the blade to flex and further secure the blade to the blade holder.

11. The blade retention mechanism of claim 1, wherein the blade holder comprises a housing, and wherein a portion of the housing may selectively rotate relative to the blade clamp to extend over at least a portion of the lever portion and hold the lever portion in the second closed position, and wherein the lever portion is only movable into the first open position when the housing and the portion of the lever arm are rotated relative to each other so the portion of the housing does not extend over the at least the portion of the lever portion.

12. The blade retention mechanism of claim 1, wherein the over-center cam is configured to press a planar face of the blade.

13. A utility knife comprising:
a removeable blade;
a blade holder that receives the removeable blade; and
a blade clamp including a lever portion and an protrusion portion coupled to a first end of the lever portion, wherein the lever portion rotates at the first end of the lever portion between a first open position and a second closed position and wherein the protrusion portion of the blade clamp defines an over-center cam that presses the removeable blade into the blade holder of the utility knife when the lever portion is rotated into the second closed position.

14. The utility knife of claim 13, further comprising a spring member between the removeable blade and the blade holder, wherein the protrusion portion of the blade clamp in the second closed position applies pressure to the spring member causing the spring member to compress and apply additional force to the removeable blade in the blade holder.

15. The utility knife of claim 13, wherein at least one end of the protrusion portion of the blade clamp engages with a notch or detent in a housing of the utility knife to further secure the removeable blade to the blade holder.

16. The utility knife of claim 13, wherein the removeable blade comprises notches or apertures that further secure the removeable blade to the blade holder of the utility knife.

17. The utility knife of claim 13, wherein the protrusion portion further comprises a peg along a length of the protrusion portion, the peg engaging a slot or notch in the blade holder, the removeable blade and/or a housing of the knife to further secure the removeable blade.

18. The utility knife of claim 17, wherein the peg extends substantially perpendicular to the protrusion portion of the blade clamp.

19. The utility knife of claim 13, wherein a clamping load provided by the blade clamp on the removeable blade is from about 8.2 kg to about 16.4 kg.

20. The utility knife of claim 13, wherein the utility knife further comprises a housing and wherein the blade clamp is flush with the housing of the utility knife in which the removeable blade is provided when the lever portion is in the second closed position.

21. The utility knife of claim 13, wherein the blade clamp rotates across the removeable blade of the knife to engage the protrusion portion against the removeable blade of the knife causing the removeable blade to flex and further secure the removeable blade to the blade holder.

22. The utility knife of claim 13, wherein the lever portion of the blade clamp is locked in place by a portion of a housing of the knife extending over at least a portion of the lever portion and wherein the lever portion is only engageable when the housing of the utility knife is rotated out of an operating position.

23. A blade retention mechanism, the blade retention mechanism comprising an actuator that moves between first and second positions, in the first position, the actuator is held in a forward position and a roller is forced down a ramp to secure a blade in the blade retention mechanism and wherein the actuator is moved into the second position to release the blade from the blade retention mechanism.

24. The blade retention mechanism of claim 23, wherein the actuator is held in the first position by a spring that forces the actuator forward to engage the roller.

25. The blade retention mechanism of claim 23, wherein moving the blade forward increases the clamping pressure on the blade.

26. The blade retention mechanism of claim 23, wherein the roller operates a catch that selectively engages a blade retaining notch on the blade.

27. The blade retention mechanism of claim 23, wherein the actuator comprises a slider or a lever.

28.-35. (cancelled)
